(19) United States
(12) Patent Application Publication
(10) Pub. No.: US 2006/0199159 A1
(43) Pub. Date: Sep. 7, 2006

(54) Head phantom for simulating the patient response to magnetic stimulation

(75) Inventors: Kenneth Marc Ghiron, Allentown, PA (US); Ravi Pillutla, Audubon, PA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Neuronetics, Inc., Malvern, PA (US)

(21) Appl. No.: 11/069,130

(22) Filed: Mar. 1, 2005

(51) Int. Cl. G09B 23/28

(52) U.S. Cl. 434/270; 600/9

(57) ABSTRACT

A simulated body part (e.g., head phantom) containing one or more sensors detects the time changing electric and magnetic fields created by a magnetic stimulation device and applied to the simulated body part. The sensors are connected to electronics that determine if the sensor output evidences that the strength of the applied magnetic field is sufficient to stimulate the patient. The measured signal levels may be varied to simulate patients with different thresholds and sensory feedback may be provided to the operator to indicate the accuracy of the positioning and orientation of the stimulation coil. The electronics may further include an analysis device that determines if the magnitude and duration of the stimulation is sufficient to stimulate the target nerves. The phantom or coil positioning apparatus also measures the location and orientation of the coil so that the trainee's positioning can be measured against a known result. A head phantom embodiment may also provide additional features such as the ability to adjust the Motor Threshold (MT) or sensor locations.

### FIELD OF THE INVENTION

The present invention relates to a simulated patient's head (head phantom) or other simulated body part containing one or more sensors to detect the time changing electric and magnetic fields created by a magnetic stimulation device used, for example, in treatment of the patient by Transcranial Magnetic Stimulation (TMS). The head phantom simulates the patient's response to the TMS treatment and also facilitates training on placement of the TMS device on a patient's head.

### BACKGROUND OF THE INVENTION

Presently training users to operate Transcranial Magnetic Stimulation (TMS) and other magnetic stimulation devices requires the users to work with human subjects. The magnetic stimulator is placed over a subject's head and the amplitude, orientation and position of the magnetic stimulation is varied to achieve a detectable result. For example, the evoked response in a particular body part is observed either by visual inspection or by detecting voltages associated with the evoked response (typically stimulated motion of a body part such as the thumb). Unfortunately, the cost of using a human subject for training is cost-prohibitive and potentially dangerous as potential errors during training could cause adverse effects in the training subject. Moreover, availability is limited for persons with a known motor threshold and possibly known MT location for training. In addition, the Motor Threshold (MT) of a human volunteer could have variability depending on the mood, caffeine in the system, and other factors. Informed patient consent is also required.

Accordingly, there is a need for training and calibration tools for users of Transcranial Magnetic Stimulation (TMS) devices. New operators of TMS machines need to learn to position and operate stimulators on patients without subjecting real patients to their trials and errors. This training includes, but is not limited to, the operations of positioning the patient, locating and orienting the coil, finding the stimulation threshold, performing treatments, and using associated equipment like contact sensing or coil locating and positioning apparatus.

There is also a need in the art for training and calibration tools to be used during the development of hardware and software for TMS devices. Such tools are needed for use in tests that are performed to evaluate the new concepts, software and equipment. At present, since such tests are performed on human subjects, the development of new technology is slowed and patients are unnecessarily put at risk. Accordingly, a tool is also desired that may be used to develop features for TMS applications such as contact sensing, position measurement, automatic threshold determination, stimulator design, and patient seats and positioning devices. In addition, it is desired that such a tool be used in the manufacturing process to assure the quality and operation of the TMS or other magnetic stimulation product as well as for the calibration and quality assured operation of stimulation systems in the field.

### SUMMARY OF THE INVENTION

The above-mentioned and other needs in the art are met by a device and method in accordance with the invention for simulating the response of a patient to an applied magnetic field. The device in accordance with the invention comprises a material formed so as to simulate a body part of the patient, such as the patient's head, and at least one sensor disposed with respect to the body part so as to determine the strength of the applied magnetic field at one or more predetermined positions in or on the body part. A circuit processes an output of the sensor to provide an indication of whether predetermined stimulation criteria are met. For example, the predetermined stimulation criteria may comprise a threshold indicating whether the applied magnetic field is sufficient to stimulate nerves of the patient's brain for a efficacious treatment of at least one of depression, addiction, post traumatic stress disorder, attention deficit disorder, schizophrenia, mania, epilepsy, seizure, bipolar disorder, cravings, obsessive compulsive disorder, and anxiety. The magnetic field may also stimulate nerves of the patient's brain for nerve conduction studies, pain relief, brain mapping, and the like.

Alternate embodiments are illustrated in which the sensor is disposed within the simulated body part out of view of an operator. For example, the sensor may comprise a pick-up loop including a coil of conductive wire, a Hall sensor, a magneto-resistive sensor, a fiber optic sensor that changes the polarization of light passing therethrough in response to variations in magnetic or electric fields applied thereto, and/or actual nerve cells that cause a measurable change in at least one of voltage and current when stimulated.

The material used to simulate the body part may be conductive such that electrodes of the sensors measure an electric field induced in the material by the applied magnetic field. The sensors also may comprise a temperature sensor that measures a temperature rise in proportion to electric fields induced in the material by the applied magnetic field. On the other hand, the material may have an electrical conductivity that is substantially the same as human tissue.

The circuit may comprise signal conditioning circuitry that processes the output of at least one sensor to simulate a physiological response in the patient and a comparison circuit that determines whether the strength of the applied magnetic field is such that the amplitude, duration, time dependence and overall field shape contribute to generation of sufficient stimulation. For example, when the stimulation is sufficient the circuit generates a simulated EMG/EEG signal to simulate an actual stimulation of a target region of the patient and/or actuates an actuator to cause a movement that simulates patient movement caused by an actual stimulation of a target region of the patient. The circuit may further include an audio, tactile or visual indicator that provides an indication when the stimulation is sufficient. The circuit may further comprise a mechanical device that is caused to move when the stimulation is sufficient. The circuit may further output a simulated evoked potential as an indication that the stimulation is sufficient. For example, when the body part is the patient's head, the predetermined stimulation criteria may comprise a threshold indicating whether an applied magnetic field is sufficient to stimulate nerves of the patient's brain.

A measuring device may also be used to measure the position and orientation with respect to the body part of a stimulation magnet and the applied magnetic field it generates. For example, the measuring device may comprise shaft encoders that measure a position and orientation of the stimulation magnet with respect to a position of the body part, which may be variable. The measuring device thus may be used to check the accuracy, stability, and reproducibility of the positioning mechanism used to position the patient.

The device of the invention may be used for a number of applications such as training an operator to position a stimulation magnet on a patient by having the operator adjust the positioning of the simulation magnet until the indication is provided to the operator. Also, when a plurality of sensors are dispersed in the body part so as to simulate unwanted stimulation of nerves that may cause patient discomfort during application of said applied magnetic field, the device of the invention may provide an indication to the operator indicative of the unwanted stimulating of the patient's nerves. The device of the invention further enables an operator to be trained to determine a threshold level for stimulation of a patient using a stimulation magnet by adjusting a stimulation threshold level of the stimulation magnet until the indication is provided to the operator. Similarly, the device of the invention also enables a user to develop a new feature for a magnetic stimulation system by positioning a stimulation magnet of the magnetic stimulation system with respect to the simulation device, activating the new feature, and monitoring indications from the circuit of the simulation device. For example, the indications may be provided when a stimulation threshold is reached, thereby providing the operator with an automatic determination of the stimulation threshold. The indications also provide an indication of whether a new design for a component of the stimulation magnet is operating as specified in the predetermined stimulation criteria. In addition, an actuator may be actuated by the circuit to cause a movement that simulates patient movement caused by an actual stimulation of a target region of the patient when the indications are provided by the circuit of the simulation device. The component being simulated may include, for example, an automatic motion detection system.

The device of the invention may also be used for testing a magnetic stimulation system during production and for calibrating the magnetic stimulation system. In each case, the magnetic stimulation system is adjusted until the indications correspond to predetermined calibrated stimulation criteria.

The device of the invention is also used to train an operator to position a stimulation magnet on a patient by enabling the operator to adjust the positioning of the simulation magnet until the indication is provided to indicate to the operator that the stimulation magnet is over the motor threshold location of the head and/or over the treatment location of the head. The stimulation threshold may also be adjusted until the stimulation magnet delivers a treatment to the treatment location as specified by the predetermined stimulation criteria. To assure variability for respective training sessions (to prevent operator memorization of where the motor threshold and treatment position are located, for example), the threshold levels of the sensors as well as the combination of sensors used may be adjusted between respective training sessions.

These and other features and advantages of the invention will become apparent to those skilled in the art based on the following detailed description.

### BRIEF DESCRIPTION OF THE DRAWINGS

The invention is further described in the detailed description that follows, by reference to the noted drawings by way of non limiting illustrative embodiments of the invention, in which like reference numerals represent similar parts throughout the several views of the drawings, and wherein:

FIG. 1 illustrates a head phantom having a sensor at predetermined locations with respect to a stimulation magnet.

FIG. 2 illustrates an embodiment of electronics in accordance with the invention whereby the output of the sensor is used to detect the fields created by the stimulator.

FIG. 3 illustrates a pick-up loop in which a coil of conducting wire is used as a sensor.

FIG. 4 illustrates a Hall or magneto-resistive sensor in which current is sent through a magnetic sensitive conductor and the developed voltages are monitored.

FIG. 5 illustrates a fiber optic sensor that is sensitive to magnetic or electrical fields so as to rotate the polarization of light traveling though the fiber.

FIG. 6 illustrates an electric field sensor in which the head phantom is filled with a conducting media and two or more electrodes are placed in the volume of interest to detect the voltage developed between the electrodes as an indication of the value of the induced electric field.

FIG. 7 illustrates the use of a temperature sensor in conjunction with a head phantom made of a conducting medium for measuring local electric fields that cause a temperature rise in proportion to the square of their strength.

FIG. 8 illustrates a simulated EMG/EEG signal generated to simulate the actual stimulation of the motor cortex or other target region.

FIG. 9 illustrates that movement of an object may simulate the stimulation of motion in a real patient due to the proper use or design of the stimulator.

FIG. 10 illustrates the use of a speaker to provide audio feedback to the trainee or design engineer.

FIG. 11 illustrates the use of a light to provide feedback to the trainee or design engineer.

FIG. 12 illustrates the measurement of position by use of a support arm that gives feedback of the position and orientation of the stimulation coil.

FIG. 13 illustrates the use of spatially separated transmitters and the measurement of time delay for reception of signals so as to allow for the detection of the position and orientation of the coil.

FIG. 14 illustrates the location of the stimulator and person in the images of one or more digital cameras for use in specifying the locations and orientations of the two.

FIG. 15 illustrates the use of a grid or other pattern on the head phantom to allow direct measurement of the position of the stimulator on the simulated patient's body.

### DETAILED DESCRIPTION OF ILLUSTRATIVE EMBODIMENTS

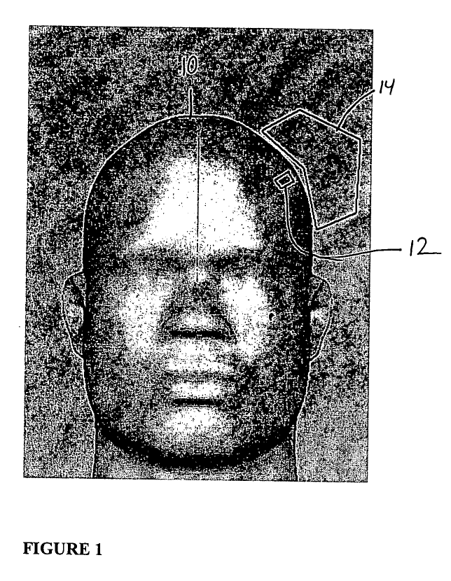

A detailed description of an illustrative embodiment of the present invention will now be described with reference to FIGS. 1-15. Although this description provides detailed examples of possible implementations of the present invention, it should be noted that these details are intended to be exemplary and in no way delimit the scope of the invention.

The present invention provides a simulated head (head phantom) containing one or more sensors that detect the time changing electric and magnetic fields created by a magnetic stimulation device and applied to the head phantom. The sensors are connected to electronics that compare the sensor output to a predetermined stimulation criteria such as amplitude, duration, time dependence and overall field shape. The stimulation criteria may be varied to simulate patients with different motor thresholds and the like and sensory feedback may be provided to the operator to indicate the accuracy of the positioning and orientation of the stimulation coil. The electronics may further include an analysis device that determines if the magnitude and duration of the stimulation is sufficient to stimulate the target nerves. The sensor(s) are preferably as sensitive to the direction of the magnetic field as the nerve stimulation. Also, the phantom or coil positioning apparatus preferably measures the location and orientation of the coil so that the trainee's positioning can be measured against a known result. The head phantom may also provide additional features such as the ability to adjust the Motor Threshold (MT) or sensor locations.

The present invention is described in the context of a patient's simulated head for use in motor threshold determination and/or placement of, for example, TMS coils against the patient's head. As described herein, the motor threshold determination on a live patient is mimicked using a head phantom having a sensor or sensors and feedback hardware for indicating to the operator whether the motor threshold has been found. In illustrative embodiments, the simulated head or other body part is made of a material that has approximately the same electrical conductivity as real tissue. For example, the test phantom may include a solution of potassium chloride in water; a solution of propylene carbonate, ethylene carbonate, and salts; a semi-solid material including silicone and carbon black; or a semi-solid mixture of glycine, carrageenan, potassium chloride, and water. The test phantom of the invention may also test the operation of the magnetic field hardware in the field or during laboratory testing.

Those skilled in the art will appreciate that other body portions of the patient may be simulated in accordance with the techniques of the invention. Those skilled in the art will also appreciate that magnetic fields may be placed with respect to the patient's body in connection with numerous other treatment modalities besides TMS. In accordance with the invention, magnetic stimulation may be used for (at least) the following indications: depression, epilepsy, addiction, schizophrenia, attention deficit disorder, mania, post traumatic stress disorder, magnetic seizure therapy, bipolar disorder, cravings, obsessive compulsive disorder and other anxiety disorders.

There are number of possible uses of the phantom system of the invention. Such uses include training users and developing and inspecting systems for the treatment of different disorders. The phantom system also can be used at different stages in the production and use of magnetic stimulation systems. Each use will have its unique requirements so that the invention may have several embodiments that would meet one or more of these requirements.

The invention also may be used in different stages of production and use of a magnetic stimulation device. For example, the invention may be used to aid the development of subsystems like the magnet design, positioning systems and contact sensing. The invention also may be used to check the calibration and function of stimulators during and at the end of production and to calibrate stimulation systems periodically after a period of use.

As with all electrical and electronic systems, the system of the invention will need to be calibrated to make sure it functions as intended. What is important is that it responds as real patients would. That is, the sensors and electronics produce feedback signals that represent the same thresholds and conditions needed to stimulate neurons in the patients. The firing of nerve cells is controlled by the strength of the electric fields and their duration. The thresholds and signal characteristics are neither identical among different people nor on the same patient at different times. Thus, the response of the testing system should be adjustable over ranges that represent the range of responses found in people or the system should be set at a fixed value that represents typical or extreme values of potential patient sensitivities. In addition, since the precise shape and conductivity of the patient changes the results, these factors also will need to be taken into account when constructing, calibrating and using the invention.

In accordance with a first embodiment of the invention, a head phantom is formed of a nonconductive material such as Styrofoam or gel and fitted with one or more sensors at predetermined locations. FIG. 1 illustrates a head phantom 10 having one or more sensors 12 at predetermined locations with respect to a stimulation magnet 14. In general, the sensors 12 and any associated wires are hidden from view (e.g., within the head phantom 10) so that the trainee or other user of the stimulation magnet 14 would not know the location of the sensor 12. In operation, the trainee or other user would seek to place the stimulation magnet 14 at a treatment position identified by the sensor 12.

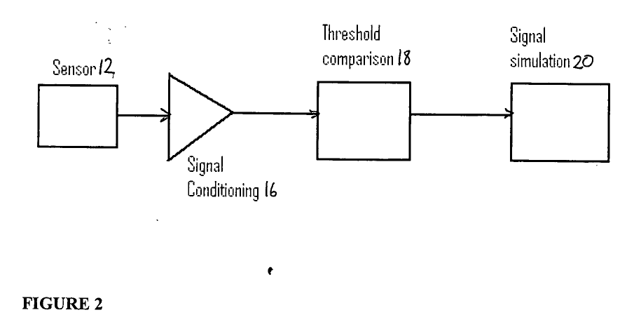

The output of sensor 12 in FIG. 1 is provided to sensing electronics for a determination of the position of the stimulation magnet 14 with respect to sensor 12. As illustrated in FIG. 2, typical sensing electronics would include signal conditioning circuit 16 that processes the output of sensor 12 to simulate a physiological response and applies the processed output to a comparison circuit 18 for a determination of whether the stimulation magnet 14 is properly positioned. Once the criteria is exceeded (i.e., the stimulation magnet 14 is properly placed with respect to sensor 12), a feedback signal to the trainee or other operator is stimulated by signal stimulation circuit 20. Thus, the circuit of FIG. 2 functions to detect the fields created by the simulation magnet 14 and to process the signals from the sensor 12 to determine if the fields are sufficient to stimulate nerves of the patient (i.e., exceed the set threshold). This processing should take into account that nerves need a sufficient strength and duration of electric fields and/or electric field gradients to be stimulated. Those skilled in the art will appreciate that the stimulation criteria depends upon the type of nerve cell. Though not necessary, in an exemplary embodiment, the circuit of FIG. 2 is also located within the head phantom 10.

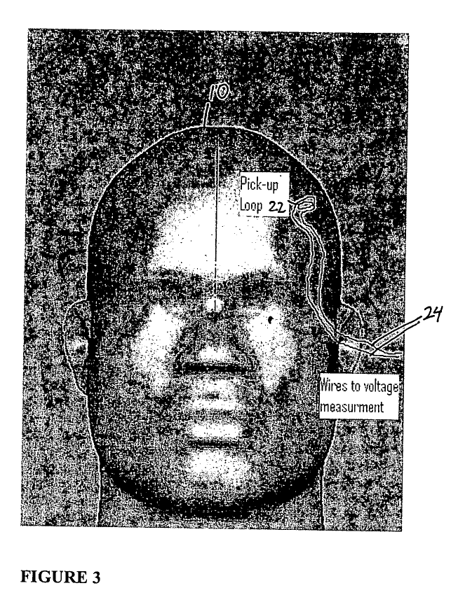

FIG. 3 illustrates an alternative embodiment in which the sensor 12 is implemented as a pick-up loop 22 comprised of a coil of conducting wire that is used as a sensor to sense one of several orthogonal components (e.g., x, y, z orientations) of the magnetic field. Alternatively, a probe could be constructed of three orthogonal pickup loops to detect all three orthogonal field components simultaneously. In this embodiment, a time variant magnetic field induces voltages in one or more pick up coils of pick-up loop 22 such that, when the stimulation magnet 14 is properly positioned and oriented, the size and time dependence of the induced voltage signal on wires 24 will indicate if nerves would be stimulated. Those skilled in the art will appreciate that changing magnetic fields induce currents in the loop that may be measured. In the embodiment of FIG. 3, the head phantom 10 is preferably constructed of a non-magnetic material with similar curvatures/topology as the region of the body to be simulated (e.g., the patient's head). Those skilled in the art will appreciate that this embodiment assumes that the shape of the magnetic field created by the stimulation magnet 14 is fixed. A feedback circuit of the type illustrated in FIG. 2 provides feedback to the trainee and/or operator. However, those skilled in the art will appreciate that the system may have two stimulation coils or a variable coil so that the shape of the magnetic field may be variable.

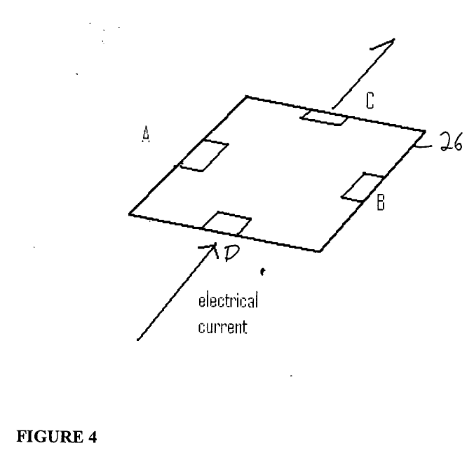

FIG. 4 illustrates another alternative embodiment in which the sensor 12 of FIG. 1 is implemented as a Hall or magneto-resistive sensor 26 in which the induced electrical current is sent through a magnetic sensitive conductor. The voltages developed would then be monitored. Of course, the sensor response time in the Hall sensor preamplifiers must consider magnitude and rate of change of the field to prevent saturation of the Hall sensors and to allow for appropriate response time. In the presence of a magnetic field, the induced voltages would change and the magnitude of the change may be monitored at contacts A and B so as to produce a Hall sensor that measures the transverse voltages perpendicular to current flowing in the head phantom material as induced by the magnetic fields. If contacts C and D are monitored instead, then the sensor 26 of FIG. 4 is called a magneto-resistive sensor that may be used to measure the resistance changes caused by the applied magnetic field. Flux collectors may be used to make the sensor directionally dependent. As in previous embodiments, a feedback circuit of the type illustrated in FIG. 2 may provide feedback to the trainee and/or operator.

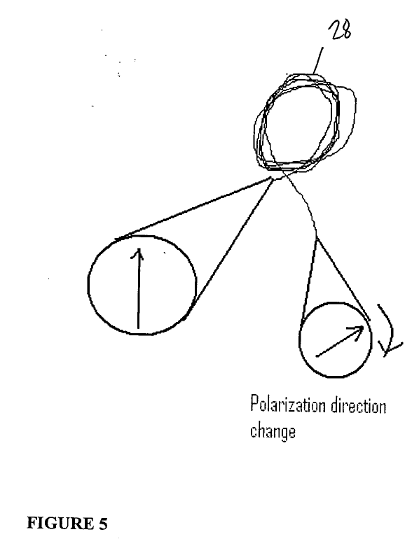

FIG. 5 illustrates an embodiment in which the sensor 12 is implemented as a fiber optic sensor 28. By using a fiber optic material that is sensitive to magnetic or electrical fields, the rotation of the polarization of light traveling though the fiber can be used to indicate the delivery of electromagnetic fields by the trainee, design engineer or other user through placement of the stimulation magnet 14. As in previous embodiments, a feedback circuit of the type illustrated in FIG. 2 may provide feedback to the trainee and/or operator.

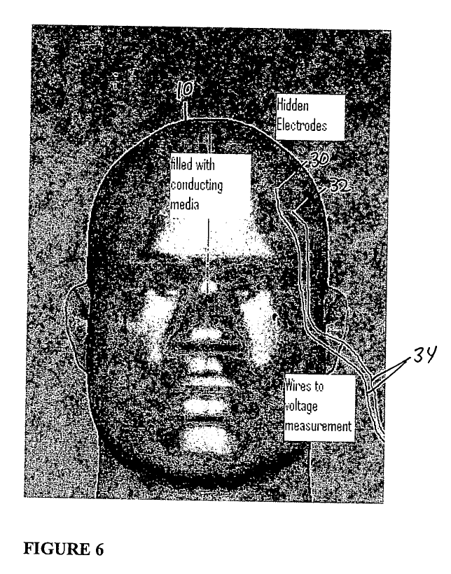

FIG. 6 illustrates an embodiment in which the head phantom 10 operates as an electric field sensor. In this embodiment, the simulated head 10 is filled with a conducting media. Two or more electrodes 30, 32 are placed in the volume of interest. The voltage developed between the electrodes 30, 32 indicates the value of the induced electric field. If the electric fields have sufficient size, proper orientation, gradients and or duration to stimulate the neurons, then this can be determined by connecting wires 34 to a feedback circuit such as that illustrated in FIG. 2 and positive feedback provided to the trainee or design engineer as would be seen in real operation. The conducting media need not be homogeneous but could be varied so as to represent the true anatomy of the internal structures of the head.

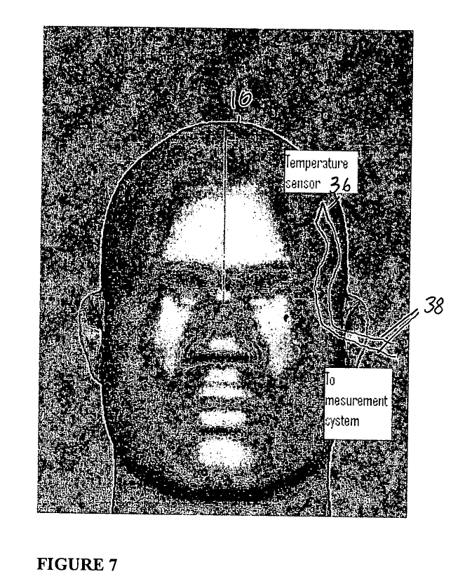

FIG. 7 illustrates yet another embodiment in which the head phantom 10 is made of a conducting medium and includes a temperature sensor 36 that measures temperature variations caused by local electric fields. As will be appreciated by those skilled in the art, local electric fields cause a temperature rise in proportion to the square of their strength. In this embodiment, sensor 36 measures the Joule heating of an anisotropic conductor as an indicator of the strength of the applied magnetic field. The temperature rise per unit time would be provided via wires 38 to a feedback circuit of the type illustrated in FIG. 2 so as to indicate the proper placement and operation of the stimulation magnet 14.

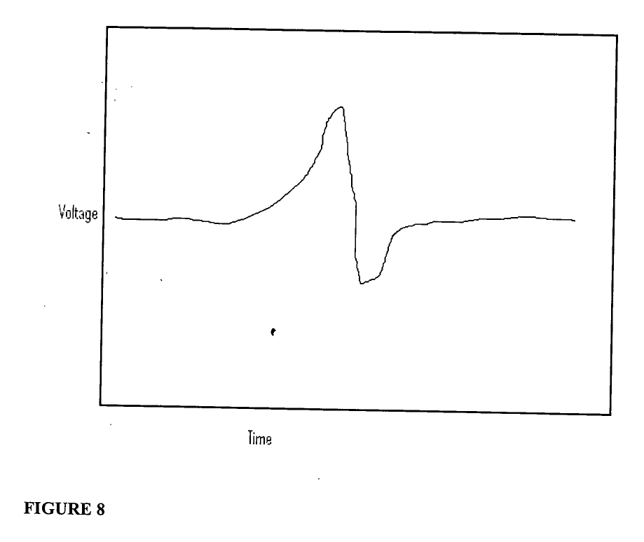

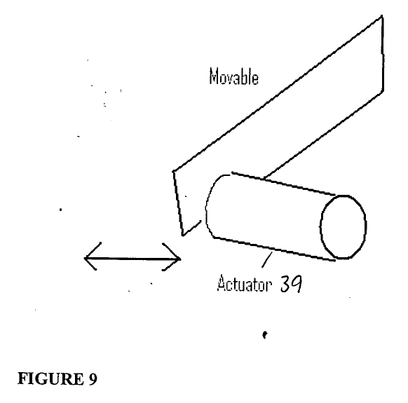

Characteristics of a live patient may be simulated by the head phantom 10 of the invention. For example, FIG. 8 illustrates a simulated EMG/EEG signal that is generated to simulate the actual stimulation of the motor cortex or other target region of a patient's head. Such a signal may be generated to simulate when nerve stimulation in the patient would be achieved. Also, as shown in FIG. 9, an object such as a simulated body part could be driven by an actuator 39 to move when sufficient fields are detected by the sensor so as to simulate the stimulation of motion in a real patient due to the proper use or design of the stimulation magnet 14.

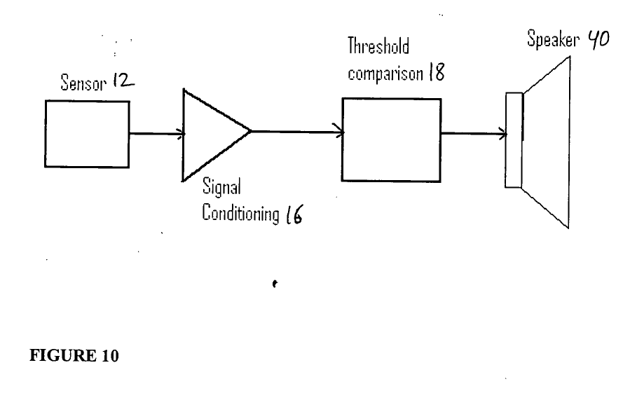

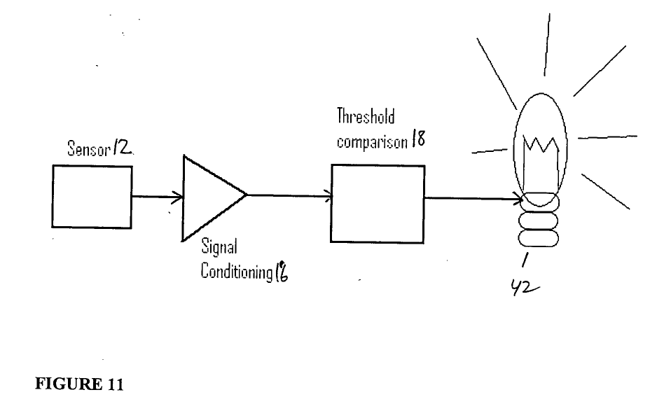

FIGS. 10 and 11 illustrate sample embodiments of the feedback electronics circuit of FIG. 2. In FIG. 10, a speaker 40 provides audio feedback to the trainee or other user when the induced fields detected at the sensor 12 would cause a nerve stimulation in the target volume of the patient. In FIG. 11, on the other hand, a light 42 is used to provide feedback to the trainee or other user when the fields detected by the sensor 12 would cause nerve stimulation in the target volume of the patient. For example, the speaker 40 would provide a audio output and light 42 would light when the stimulation magnet 14 is over the motor threshold of the head phantom 10. Of course, other types of nerve stimulation feedback, such as tactile feedback, may also be measured in accordance with the invention.

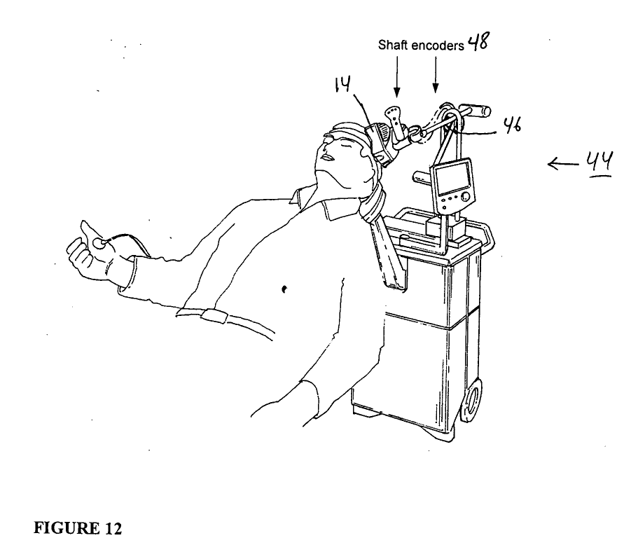

FIGS. 12-14 illustrate embodiments of a positioning apparatus 44 that provides a precise indication of the location of the stimulation magnet 14 with respect to the patient (or a head phantom 10 simulating the patient's head). In FIG. 12, the position of support arm 46 is measured by shaft encoders 48 that provide feed back of the position and orientation of the stimulation coil 14. In this embodiment, the position of the stimulation magnet 14 may be compared with a known position of the head phantom 10 to determine if the stimulation magnet 14 is placed properly. As in the other embodiments, an appropriate feedback signal is also provided.

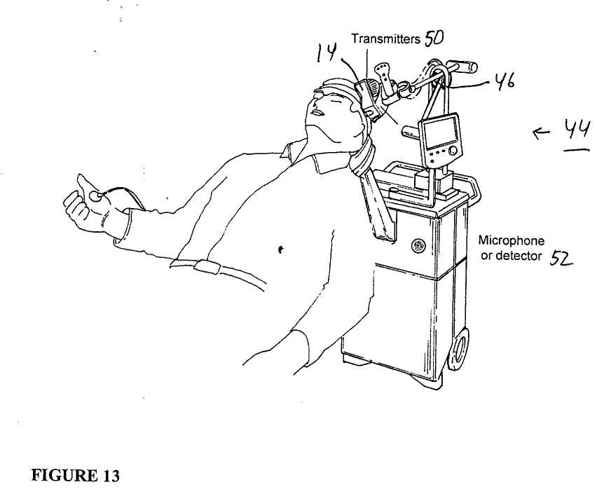

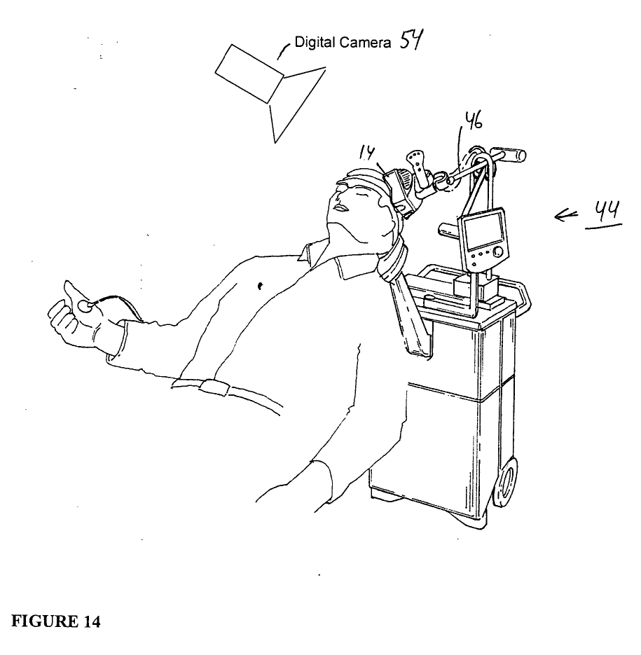

In the embodiment of FIG. 13, on the other hand, spatially separated transmitters 50 measure the time delay for reception of signals in order to detect the position and orientation of the stimulation magnet 14. An electromagnetic and/or acoustic signal is provided to the microphone or detection circuitry 52 as a feedback indication of the position of the stimulation magnet 14 with respect to the head phantom 10. FIG. 14 illustrates an alternative embodiment in which the location of the stimulation magnet 14 and the head phantom 10 (or person) in the images of one or more digital cameras 54 are used to specify the locations and orientations of the head phantom 10 and stimulation magnet 14 with respect to each other. Special indicators such as LEDs, barcodes, fluorescent markers and intrinsic features also may be used to aid in the image analysis.

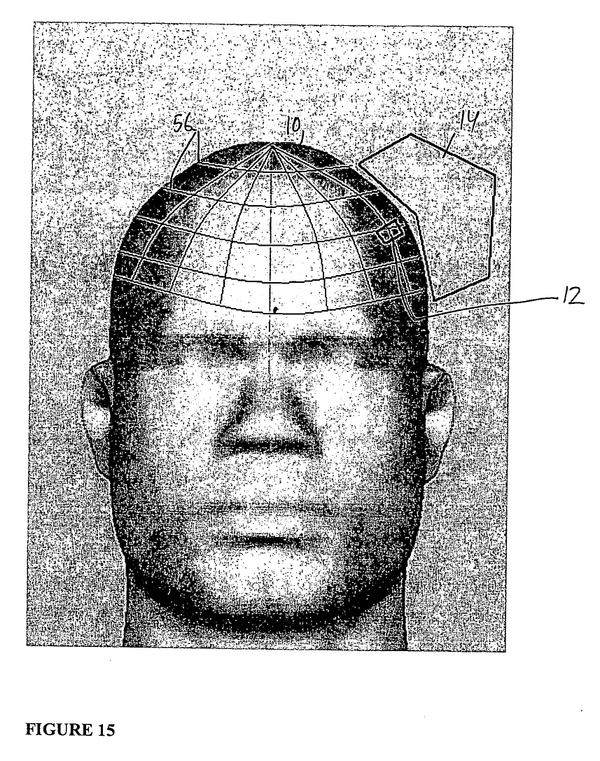

FIG. 15 illustrates an alternative embodiment of the invention in which a grid or other pattern 56 is placed on the head phantom 10 to allow direct measurement of the position of the stimulation magnet 14 on the simulated patient's body.

Those skilled in the art will appreciate that since not all of the proposed sensor types directly measure the electric field some differences will exist on how the sensors should be calibrated. For example, induced heating (FIG. 7) will depend on the square of the electrical field as well as the electrical and thermal conductivity of the medium used to simulate tissue. The shape of the head phantom 10 will also play a role in the flow of current and heat and affect the result. Thus, these factors must be accounted for in making a correlation to the electric field.

Those skilled in the art will also appreciate that an electric field is induced by time variant magnetic fields from the stimulation magnet 14. The precise shape of the magnetic field is important in the relation between the two fields. Thus, a calibration of the correlation between the sensor's output and the electrical field will only apply as long as the shape of the magnetic field is held constant. If a magnetic field sensing system is used to aid in the development of coil designs, the correlation between the magnetic field and the electric field would need to be determined by calculation or direct measurement. In such a case, the phantom could be designed to produce a calibrated output that relates to physiologic stimulation parameters (e.g., dB/dt) at a particular standard spatial position. For example, induced electric field could be measured at a depth of 2 cm from the stimulating coil to approximate induced electric field in the patient's cortex. The measured value could be calibrated to determine if the applied electric field would be above the stimulation threshold for the cortical tissues. The sensor could be a pickup loop for magnetic field sensing or a dipole in a conductive medium for electric field sensing.

The invention also contemplates several possible embodiments of a coil positioning system for positioning the magnetic coil with respect to the head phantom. For example, gravity or magnetic field sensors also may be used to determine the orientation of the stimulation magnet (coil) 14. The transmission times of signals such as light or ultrasound between the coil 14 and external reference points may be used to indicate the position and orientation of the coil 14. On the other hand, direct measurement of the stray fields created by the operation of the stimulation magnet 14 may indicate the coil's position and orientation. Alternatively, contact sensors may determine the points of contact between the stimulation magnet and the head phantom 10. The head phantom 10 could be held in a known fixed location or mechanisms may be used to determine and vary its position.

Those skilled in the art will appreciate that other sensing devices may be used to determine whether the TMS coil assembly is properly placed against the patient's head. For example, actual nerve cells may be used as the sensing device. The stimulation of the nerves could be measured by changes in voltages or the flow of current. Those skilled in the art will also appreciate that multiple coils (tiny pickup loops) may be placed in the head phantom 10 and selected using a selection mechanism to thereby randomize the field detection and to permit the head phantom to be used for various indications. Similarly, the threshold levels may be adjusted between training sessions to randomize the field detection as would occur between respective patients. The phantom of the invention may also be used to train in the proper application of EMG/EEG sensors. Accordingly, any such modifications are intended to be included within the scope of this invention as defined by the following exemplary claims.

What is claimed:

1. A device that simulates the response of a patient to an applied magnetic field, comprising:
a material formed so as to simulate a body part of the patient;
at least one sensor disposed with respect to said body part so as to determine the strength of the applied magnetic field at one or more predetermined positions in or on said body part; and
a circuit that processes an output of said sensor to provide an indication of whether predetermined stimulation criteria are met.

2. The device of claim 1, wherein the simulated body part is the patient's head.

3. The device of claim 1, wherein the at least one sensor is disposed within the simulated body part out of view of an operator.

4. The device of claim 1, wherein the at least one sensor comprises a pick-up loop including a coil of conductive wire.

5. The device of claim 1, wherein the at least one sensor comprises a Hall sensor.

6. The device of claim 1, wherein the at least one sensor comprises a magneto-resistive sensor.

7. The device of claim 1, wherein said at least one sensor comprises a fiber optic sensor that changes the polarization of light passing therethrough in response to variations in magnetic or electric fields applied thereto.

8. The device of claim 1, wherein said at least one sensor comprises actual nerve cells that cause a measurable change in at least one of voltage and current when stimulated.

9. The device of claim 1, wherein said material is conductive and said at least one sensor comprises electrodes that measure an electric field induced in said material by said applied magnetic field.

10. The device of claim 1, wherein said material is conductive and said at least one sensor comprises a temperature sensor that measures a temperature rise in proportion to electric fields induced in said material by said applied magnetic field.

11. The device of claim 1, wherein said circuit comprises signal conditioning circuitry that processes the output of at least one sensor to simulate a physiological response in the patient and a comparison circuit that determines whether the strength of the applied magnetic field is sufficient to stimulate the patient.

12. The device of claim 11, wherein when the strength of the applied magnetic field is sufficient to stimulate the patient the circuit generates a simulated EMG/EEG signal to simulate an actual stimulation of a target region of the patient.

13. The device of claim 11, wherein when the strength of the applied magnetic field is sufficient to stimulate the patient the circuit actuates an actuator to cause a movement that simulates patient movement caused by an actual stimulation of a target region of the patient.

14. The device of claim 11, wherein the circuit further comprises an indicator that outputs at least one of an audio, tactile or visual indication when the strength of the applied magnetic field is sufficient to stimulate the patient.

15. The device of claim 11, wherein the circuit outputs a simulated evoked potential as an indication that the strength of the applied magnetic field is sufficient to stimulate the patient.

16. The device of claim 1, wherein the body part is the patient's head and the predetermined stimulation criteria comprises a threshold indicting whether an applied magnetic field is sufficient to stimulate nerves of the patient's brain.

17. The device of claim 16, wherein the predetermined stimulation criteria comprises a threshold indicating whether the applied magnetic field is sufficient to stimulate nerves of the patient's brain for a efficacious treatment of at least one of depression, addiction, post traumatic stress disorder, attention deficit disorder, schizophrenia, mania, epilepsy, seizure, bipolar disorder, cravings, obsessive compulsive disorder, and anxiety.

18. The device of claim 1, wherein the material has an electrical conductivity that is substantially the same as human tissue.

19. A device that simulates the response of a patient to an applied magnetic field, comprising:
a material formed so as to simulate a body part of the patient;
at least one sensor disposed with respect to said body part so as to determine the strength of the applied magnetic field at one or more predetermined positions in or on said body part;
a circuit that processes an output of said sensor to provide an indication of whether predetermined stimulation criteria are met; and
a measuring device that measures position and orientation with respect to said body part of a stimulation magnet that generates said applied magnetic field.

20. The device of claim 19, wherein said measuring device comprises shaft encoders that measure a position and orientation of said stimulation magnet with respect to a position of said body part.

21. The device of claim 20, wherein the position of the body part is variable.

22. A method of training an operator to position a stimulation magnet on a patient, comprising the steps of:
positioning the stimulation magnet with respect to the simulation device of claim 1; and
adjusting the positioning of the simulation magnet until said indication is provided to the operator.

23. The method of claim 22, wherein said at least one sensor comprises a plurality of sensors dispersed in said body part so as to simulate unwanted stimulation of nerves that may cause patient discomfort during application of said applied magnetic field, including the further step of providing indications to the operator indicative of said unwanted stimulating of said nerves.

24. A method of training an operator to determine a threshold level for stimulation of a patient using a stimulation magnet, comprising the steps of:
positioning the stimulation magnet with respect to a target position of the simulation device of claim 1; and
adjusting a stimulation threshold level of the stimulation magnet until said indication is provided to the operator.

25. A method of developing a new feature of a magnetic stimulation system, comprising the steps of:
positioning a stimulation magnet of the magnetic stimulation system with respect to the simulation device of claim 1;
activating the new feature of the magnetic stimulation system; and
monitoring indications from said circuit of said simulation device.

26. The method of claim 25, wherein said indications indicate whether the stimulation magnet is in contact with said simulation device of claim 1.

27. The method of claim 25, wherein said indications are provided when a stimulation threshold is reached, thereby providing the operator with an automatic determination of the stimulation threshold.

28. The method of claim 25, wherein said indications provide an indication of whether a new design for a component of the stimulation magnet is operating as specified in said predetermined stimulation criteria.

29. The method of claim 28, further including the step of actuating an actuator to cause a movement that simulates patient movement caused by an actual stimulation of a target region of the patient when said indications are provided by said circuit of said simulation device and said component includes an automatic motion detection system that performs the step of automatically detecting movement caused by said actuator.

30. A method of testing a magnetic stimulation system during production, comprising the steps of:
positioning a stimulation magnet of a production magnetic stimulation system with respect to the simulation device of claim 1;
activating the production magnetic stimulation system; and
monitoring indications from said circuit of said simulation device.

31. A method of calibrating a magnetic stimulation system, comprising the steps of:
positioning a stimulation magnet of the magnetic stimulation system with respect to the simulation device of claim 1;
activating the magnetic stimulation system;
monitoring indications from said circuit of said simulation device; and
adjusting said magnetic stimulation system until said indications correspond to predetermined calibrated stimulation criteria.

32. A device that simulates the response of a patient to an applied magnetic field, comprising:
a material formed so as to simulate a head of the patient;
at least two sensors disposed with respect to said head so as to determine the strengths of the applied magnetic field at a motor threshold location and a treatment location of said head; and
a circuit that processes outputs of said sensors to provide an indication of whether predetermined stimulation criteria are met.

33. A method of training an operator to position a stimulation magnet on a patient, comprising the steps of:
positioning the stimulation magnet with respect to the simulation device of claim 32; and
adjusting the positioning of the simulation magnet until said indication is provided to indicate to the operator that the stimulation magnet is over the motor threshold location of the head.

34. The method of claim 33, comprising the further step of adjusting the positioning of the simulation magnet until said indication is provided to indicate to the operator that the stimulation magnet if over the treatment location of the head.

35. The method of claim 34, comprising the further step of adjusting a stimulation threshold level of the stimulation magnet until the stimulation magnet delivers a treatment to the treatment location as specified by predetermined stimulation criteria.

36. The method of claim 35, comprising the further step of adjusting threshold levels of said sensors between respective training sessions.

37. The method of claim 33, wherein multiple sensors are disposed with respect to said head, including the further step of selecting different combinations of sensors for use in different training sessions.

38. A device that simulates the response of a patient to an applied magnetic field, comprising:
a material formed so as to simulate a body part of the patient;
at least one sensor disposed with respect to said body part so as to determine the strength of the applied magnetic field at one or more predetermined positions in or on said body part; and
a circuit that processes an output of said sensor to provide a simulated evoked potential when predetermined stimulation criteria are met.

39. A method of providing automated threshold detection during stimulation of a patient using a magnetic stimulation system, comprising the steps of:
positioning a stimulation magnet of the magnetic stimulation system with respect to the simulation device of claim 38;
activating the magnetic stimulation system until said simulated evoked potential is generated;
measuring the simulated evoked potential; and
determine whether a threshold has been exceeded by the simulated evoked potential.
